(19) United States
(12) Patent Application Publication
(10) Pub. No.: US 2025/0148657 A1
(43) Pub. Date: May 8, 2025

(54) DATASET-LEVEL SOCIETAL BIAS MITIGATION WITH TEXT-TO-IMAGE MODEL

(71) Applicant: Sony Group Corporation, Tokyo (JP)

(72) Inventors: Yusuke Hirota, Osaka (JP); Jerone Andrews, London (GB); Dora Zhao, Stanford, CA (US); Orestis Papakyriakopoulos, Zurich (CH); Apostolos Modas, Lausanne (CH); Alice Xiang, Seattle, WA (US)

(21) Appl. No.: 18/886,531

(22) Filed: Sep. 16, 2024

Related U.S. Application Data
(60) Provisional application No. 63/595,656, filed on Nov. 2, 2023.

(51) Int. Cl. G06T 11/00; G06V 10/776

(52) U.S. Cl. CPC G06T 11/00; G06V 10/776

(57) ABSTRACT

Systems and methods are used to mitigate societal bias in image-text datasets by removing spurious correlations between protected groups and image attributes. Using text-guided inpainting models, the methods ensures protected group independence from all attributes and mitigates inpainting biases through data filtering. Evaluations on multi-label image classification and image captioning tasks show that the methods effectively reduce bias without compromising performance across various models.

### CROSS-REFERENCE TO RELATED APPLICATIONS

This application claims the benefit of priority of U.S. provisional patent application No. 63/595,656, filed Nov. 2, 2023, the contents of which are herein incorporated by reference.

### BACKGROUND OF THE INVENTION

### 1. Field of the Invention

Embodiments of the invention relate generally to systems and methods for limiting bias in datasets. More particularly, embodiments of the invention relate to methods and systems for mitigating societal bias in image-text datasets by removing spurious correlations between protected groups and image attributes.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Models trained on biased data can develop prediction rules based on spurious correlations (i.e., associations devoid of causal relationships), perpetuating and amplifying harmful stereotypes. For example, image captioning models may generate gendered captions by associating gender with depicted activities, location, or objects. Resampling approaches balance the co-occurrence of each attribute with each group. However, models can still exploit correlations between groups and sets of attributes, even when individual attributes are balanced. Moreover, spurious correlations extend to unlabeled attributes, which current strategies do not address—e.g., gender disparities in image color statistics or the person-to-object spatial distances.

While equal group distributions in real-world datasets are challenging to achieve, generative text-to-image models now enable targeted image modifications. For example, bias detection methods alter image subjects' appearance to assess counterfactual fairness or model bias. However, manipulating individuals' appearances without consent raises significant ethical and privacy concerns.

In view of the foregoing, there is a need for improved dataset-level bias mitigation to reduce spurious correlations between labeled image attributes and protected groups.

### SUMMARY OF THE INVENTION

Aspects of the present invention provide systems and methods to address the challenges in conventional bias mitigation approaches by creating training datasets with text-guided inpainting, ensuring attribute distributions are independent of protected groups. Using masked person images and text prompts, aspects of the present invention can generate counterfactual images by inpainting only the masked regions, addressing ethical concerns of altering nonconsensual persons and ensuring equal representation of protected groups across attributes. Aspects of the present invention can introduce data filters to mitigate biases from generative text-guided inpainting models, evaluating images based on adherence to prompts, preservation of attributes and semantics, and color fidelity, validated by human evaluators.

Unlike conventional approaches, training on the counterfactual data decorrelates both labeled and unlabeled attributes from protected groups without impacting model performance. Comprehensive evaluations show approaches according to aspects of the present invention significantly reduces prediction rules based on spurious correlations in multi-label classification and image captioning across various architectures (e.g., ResNet-50, Swin Transformer), datasets (COCO, Open-Images), and protected groups (gender, skin tone).

In contrast to conventional bias mitigation work, aspects of the present invention can use text-guided inpainting to generate synthetic training datasets that ensure equal representation of protected groups across all attribute combinations, whether labeled or unlabeled. To mitigate inpainting biases, data filters are proposed to produce higher quality and less biased synthetic data. Aspects of the present invention go beyond previous work focused solely on gender bias mitigation by also addressing skin tone biases.

Aspects of the present invention can provide various contributions over conventional methods, including, but not limited to (1) Introducing a framework for generating synthetic training datasets with group-independent image attribute distributions; (2) Proposing data filtering to mitigate biases introduced by generative inpainting models; (3) Conducting quantitative experiments, demonstrating significant bias reduction in classification and captioning tasks compared to baselines; and (4) Identifying limitations of training on combined real and synthetic datasets, emphasizing the need for cautious synthetic data augmentation.

Embodiments of the present invention provide a method and a non-transitory computer readable storage medium tangibly embodying a computer readable program code having computer readable instructions that, when executed, causes a computer device to carry out the method for mitigating societal bias in a dataset, comprising using a text-guided inpainting model to inpaint a person mask in an original image of the dataset with a synthetic person from a protected group to generate a synthetic image; maintaining consistent context of the original image; and creating a training dataset with group-independent image attribute distributions using the synthetic image.

Embodiments of the present invention provide a computer-implemented method for generating a synthetic training dataset with group-independent image attribute distributions, comprising using a text-guided inpainting model to inpaint a person mask in an original image of an original dataset with a synthetic person from a protected group to generate a synthetic image; maintaining consistent context of the original image; and creating the synthetic training dataset with group-independent image attribute distributions using the synthetic image, wherein the synthetic training dataset includes multiple synthetic images for the original image.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1A and 1B illustrate predicted objects by baseline ResNet-50 and with conventional bias mitigation, i.e., over-sampling compared to methods according to aspects of the present invention;

FIGS. 1C and 1D illustrate generated captions by baseline ClipCap and with conventional bias mitigation, i.e., LIBRA compared to methods according to aspects of the present invention, where incorrect predictions, possibly affected by gender-object correlations, are highlighted;

FIGS. 2A through 2C illustrate an overview of a pipeline for binary gender as a protected attribute, according to an exemplary embodiment of the present invention, where synthesized images are highlighted by a picture frame;

FIG. 2D illustrates results from the filtering and ranking module of the pipeline of FIG. 2B, where synthesized images (highlighted by picture frames) are ranked using filters to select high-quality, unbiased samples;

FIG. 2E illustrates results from the create dataset module of the pipeline of FIG. 2C, where selected images are used to construct datasets with group-independent image attribute distributions, where synthesized images are highlighted by a picture frame;

FIGS. 3A and 3B illustrate predicted captions for original (left) and inpainted (right) test images;

FIG. 4 illustrates a table showing classification performance and gender bias scores of ResNet-50, Swin-T, and ConvNeXt-B backbones on COCO, where the ratio is inapplicable to Adversarial due to its gender prediction module for mitigation, and bold and underline represent the best and second-best, respectively, where, for an unbiased model, Ratio=1 and Leakage=0;

FIG. 5 illustrates a table showing captioning quality and gender bias scores of ClipCap, BLIP-2, and Transformer backbones on COCO, where M and CS denote METEOR and CLIPScore and bold and underline represent the best and second-best, respectively, where, for an unbiased model, Ratio=1 and LIC=0;

FIGS. 6A and 6B illustrates a table showing a comparison of the original (Ratio_{orig}) and inpainted (Ratioᵢₙₚ) versions of the COCO test set, where the relative difference is denoted by Δ=100·|(Ratio_{orig}−Ratioᵢₙₚ)/Ratio_{orig}|%, where a larger Δ signifies a greater change; and

FIG. 7 illustrates a table showing human evaluation and captioning quality (CLIPScore, CS in short) for each filter combination, where higher values indicate better alignment with original images and where bold and underline represent the best and second best score for each metric.

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G or the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide systems and methods for mitigating societal bias in image-text datasets by removing spurious correlations between protected groups and image attributes. Using text-guided inpainting models, the methods ensures protected group independence from all attributes and mitigates inpainting biases through data filtering. Evaluations on multi-label image classification and image captioning tasks show that the methods effectively reduce bias without compromising performance across various models.

### Methods

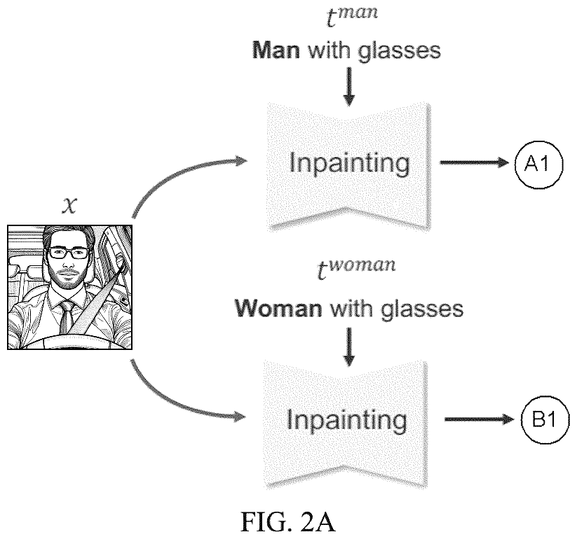

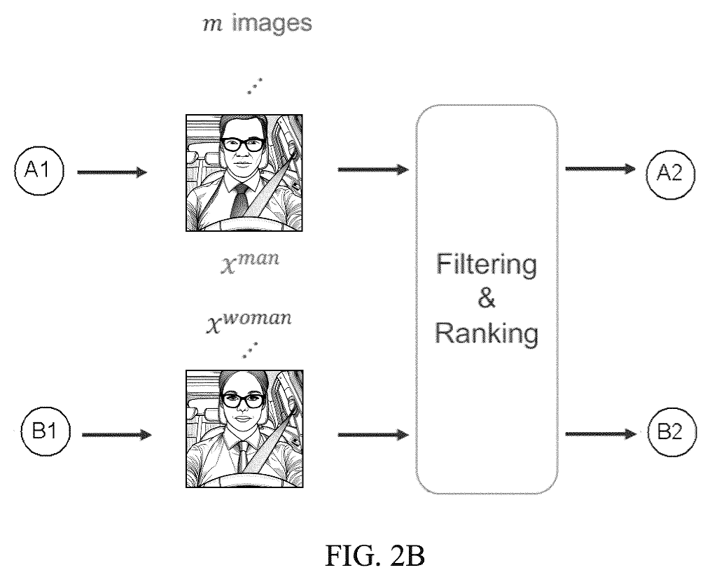

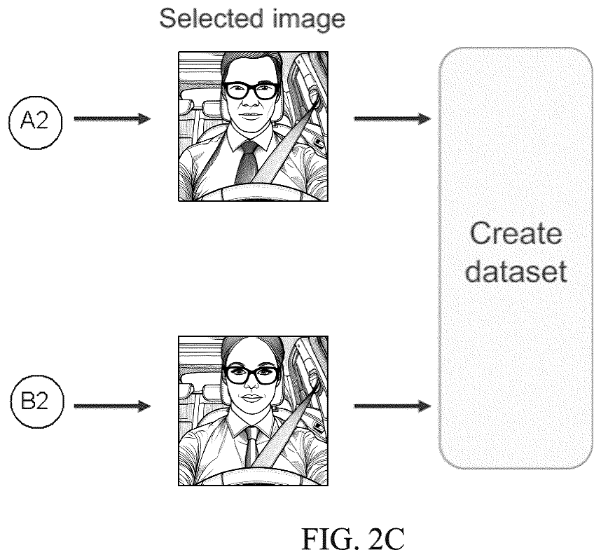

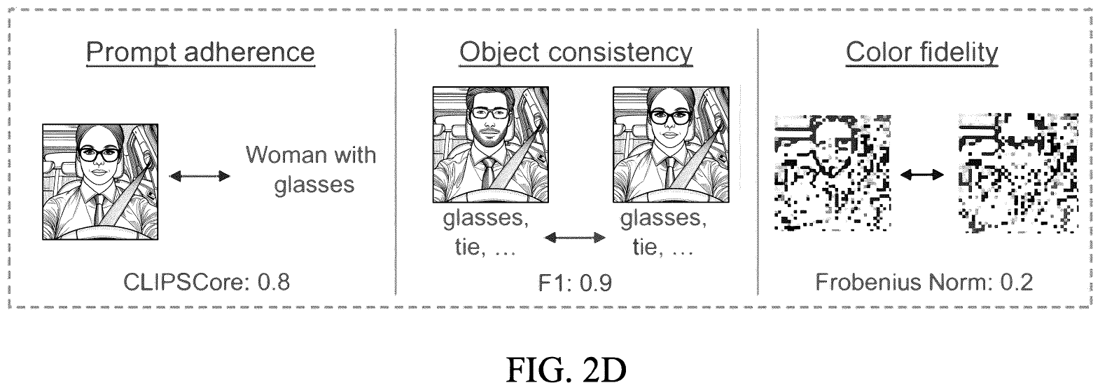

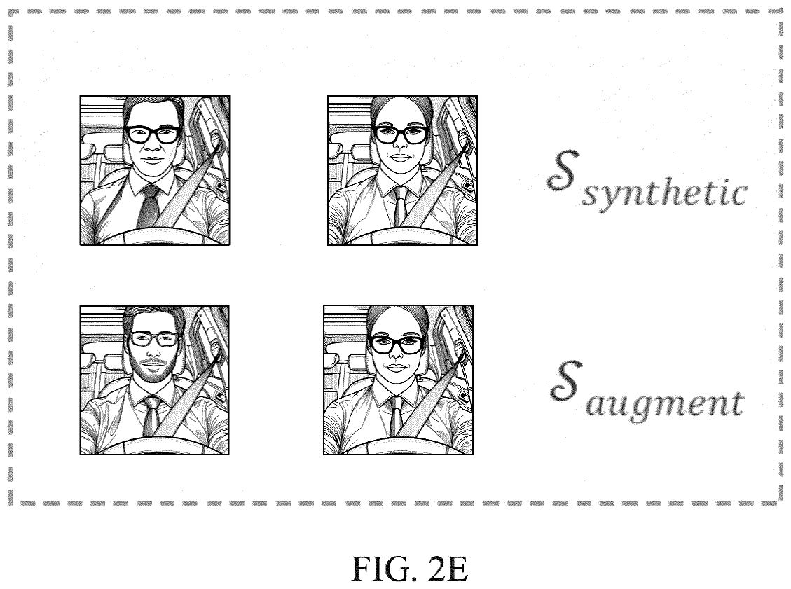

Training datasets were created with group-independent image attribute distributions by using masked person images and text prompts with a diffusion model, as outlined in FIGS. 2A through 2E.

Resampled datasets are not enough. An image is denoted by x∈ [symbol] , a protected group is denoted by g∈ [symbol] , and an image attribute is denoted by a∈ [symbol] . A spurious correlation exists if px (a|g)≠px (a), indicating biases in the data. Resampling aims to remove these biases by adjusting the sampling process so that px (a|g)=px (a) for all g. This is done using a limited set of labeled attributes [symbol] ⊂ [symbol] , where attributes a are drawn from a distribution q(a) over [symbol] and groups g are drawn from a uniform distribution u(g) over G such that [symbol] ′={x˜px(x|g, a)|a˜q(a), g˜u(g)}. This ensures px′(a |g)=q(a) for a∈ [symbol] and g∈ [symbol] . However, this method has a limitation: it does not account for a being an unlabeled attribute or a combination of labeled and unlabeled attributes, making it difficult to sample x from px (x|g, a) due to insufficient information about a. In short, while resampling can reduce biases, it is not always enough, especially when dealing with unlabeled or mixed attributes.

Text-Guided Inpainting. Suppose [symbol] ={(xᵢ, ωᵢ, aᵢ, tᵢ^{(g)})|1≤i≤n} is a training set, where x∈ [symbol] ^{d} is an image, ω∈[0, 1]^{d} is a person mask, a is a labeled image attribute, a combination of labeled attributes, or an unlabeled attribute, and t(g) is a text prompt containing a protected group-specific word g. To create a dataset with group-independent image attribute distributions, a text-guided inpainting model can be utilized. This model, guided by t(g), inpaints ω in x with a synthetic person from protected group g described in t(g). For each tuple in D, m∈ [symbol] ⁺versions are generated for each g∈ [symbol] , resulting in m·| [symbol] | samples:

$${𝒟}_{synthetic} = \{ ( {x}_{i}^{( j , {g}^{′} )} , {ω}_{i} , {a}_{i} , {t}_{i}^{( {g}^{′} )} ) \vert 1 \leq i \leq n , {g}^{′} ∈ 𝒢 , 1 \leq j \leq m \} , \qquad ( 1 )$$

where xᵢ^{(j, g′)} denotes the j-th inpainted version of xᵢ∈ [symbol] for g′ and tᵢ^{(g′)} the modified text prompt where g in tᵢ^{(g)} is replaced with g′.

Societal Bias Data Filtering. Text-to-image generative models often perpetuate societal biases, portraying certain groups stereotypically, such as depicting women in brighter clothing. Since these biases remain largely unaddressed, methods of the present invention can set m>1 in Equation (1) to generate multiple variations for each group. Aspects of the present invention propose filters to select the least biased inpainted images, evaluating images based on adherence to text prompts, preservation of attributes and semantics, and color fidelity. Specifically, for each tuple (i, g′), methods can select the highest quality and least biased version among the m versions to create a training dataset:

$${𝒮}_{synthetic} = \{ ( {x}_{i}^{( {j}^{★} , {g}^{′} )} , {ω}_{i} , {a}_{i} , {t}_{i}^{( {g}^{′} )} ) ∈ {𝒟}_{synthetic} \vert ∀ ( i , {g}^{′} ) , {j}^{★} \} , \\ where {j}^{★} = arg {min}_{j} {\sum }_{k} {c}_{k} \cdot r ( {s}_{k}^{( i , j , {g}^{′} )} ) , \qquad ( 2 )$$

cₖ∈ [symbol] are weights assigned to filters sₖ, sₖ^{(i,j,g′)} is the score obtained from applying filter sₖ to image xᵢ^{(j, g′)} for group g′, and r(sₖ^{(i,j,g′)}) is the rank of the score for (i, g′) in descending order, with lower ranks indicating less bias. Here, xᵢ^{(j★,g′)} is the selected inpainted image for tuple (i, g′) that minimizes the sum of the ranks of the weighted filter scores, with j^{★} representing the index of the selected candidate image for tuple (i, g′).

Rather than creating an entire dataset of synthetic samples, aspects of the present invention can augment [symbol] :

$${𝒮}_{augment} = 𝒟 ⋃ \{ ( {x}_{i}^{( {j}^{★} , {g}^{′} )} , {ω}_{i} , {a}_{i} , {t}_{i}^{( {g}^{′} )} ∈ {𝒟}_{synthetic} \vert ∀ ( i , {g}^{′} \neq g ) , {j}^{★} \} . \qquad ( 3 )$$

The condition g′≠g ensures that inpainted images are added to [symbol] for groups different from those originally present in xᵢ. In contrast to resampling, S_{synthetic} and S_{augment} ensure px′(a|g)=px (a) for all g ∈ [symbol] without making assumptions about [symbol] . Filters, according to aspects of the present invention, are introduced below.

Prompt Adherence. To evaluate the semantic alignment between xᵢ^{(j,g′)} and tᵢ^{(g′)}, methods can use CLIPScore, which computes the cosine similarity between their CLIP embeddings. Formally,

$${s}_{prompt}^{( i , j , {g}^{′} )} = ϕ ( {x}_{i}^{( j , {g}^{′} )} ) \cdot ψ ( {t}_{i}^{( {g}^{′} )} ) ∈ [ - 1 , 1 ] , \qquad ( 4 )$$

where ϕ and ψ are CLIP's vision and text encoders, respectively. If sₚᵣₒₘₚₜ^{(i,j,g′)}>sₚᵣₒₘₚₜ^{(i,j′,g′)}, then xᵢ^{(j,g′)} better reflects the content described in tᵢ^{(g′)}.

Object Consistency. To prevent the introduction of spurious correlations, such as generating objects not mentioned in tᵢ^{(g′)} or reinforcing stereotypes, methods can assess the object similarity between predicted objects in xᵢ^{(j,g′)} and xᵢ. Concretely, methods can compute the F1 score using a pretrained object detector, denoted η:

$${s}_{object}^{( i , j , {g}^{′} )} = F 1 [ η ( {x}_{i}^{( j , {g}^{′} )} ) , η ( {x}_{i} ) ] ∈ [ 0 , 1 ] . \\ If {s}_{object}^{( i , j , {g}^{′} )} > {s}_{object}^{( i , {j}^{′} , {g}^{′} )} , \qquad ( 5 )$$

then xᵢ^{(j,g′)} better preserves the integrity of the original unmasked scene in xᵢ.

Color Fidelity. Generative models can introduce subtler biases, including those related to color. Addressing color biases is crucial as color choices can implicitly carry cultural or gendered connotations. To mitigate this, methods can downsample xᵢ^{(j,g′)} and xᵢ to 14×14 pixels to focus on color rather than fine details, then measure the color difference using the Frobenius norm:

$${s}_{color}^{( i , j , {g}^{′} )} = {‖ {( {x}_{i}^{( j , {g}^{′} )} )}_{↓ 14 \times 14} - {( {x}_{i} )}_{↓ 14 \times 14} ‖}_{F}^{- 1} . \\ If {s}_{color}^{( i , j , {g}^{′} )} > {s}_{color}^{( i , {j}^{′} , {g}^{′} )} , \qquad ( 6 )$$

then xᵢ^{(j,g′)} has better color fidelity to the original unmasked scene in xᵢ.

### Experiments

The synthetic dataset creation method, according to aspects of the present invention, can be evaluated on multi-label image classification and image captioning tasks using quantitative metrics, human studies, qualitative comparisons and effectiveness analysis. Evaluations are conducted on test sets of real data.

Implementation Details. Methods can inpaint the largest person in the image based on bounding box size, and if the second largest person exceeds 55,000 pixels, the methods can also inpaint that region, using the person label for COCO. For image generation, methods can create m=30 inpainted images per group (e.g., woman, man) using guidance scales of 7.5, 9.5, and 15.0 to ensure diversity. Filter weights are set to 1 (i.e., cₖ=1 for all k), contributing equally. Results are based on five models trained with different random seeds.

### Multi-Label Classification

Experimental Setup. Experiments were designed to focus on gender bias using the COCO dataset, retaining only images with gender-specific terms (e.g., woman, man) in their captions. This results in 28,487/13,487 train/test samples. Experiments focused on objects cooccurring with these terms, yielding 51 objects. ResNet50, Swin Transformer Tiny (Swin-T), and ConvNext models were fine-tuned using early stopping. Performance was assessed using mean average precision (mAP). Bias is quantified using leakage and ratio. Leakage measures how much the model's predictions amplify the group's information compared to the ground truth. A gender classifier f_{g}(y), predicting gender group g from input y (i.e., set of objects), is trained on a training set T={(y, g)}. For the test set T′, the model's leakage score is:

$${LK}_{M} = \frac{1}{\vert {𝒯}^{′} \vert} {\sum }_{( y , g ) ∈ {𝒯}^{′}} {f}_{g} ( y ) [ arg {max}_{{g}^{′}} {f}_{{g}^{′}} ( y ) = g ] \qquad ( 7 )$$

The leakage score for the original dataset, LK_{D}, is similarly computed. The final leakage is Leakage=LK_{M}−LK_{D}. Higher leakage indicates greater model exploitation of protected group information. Ratio measures the exploitation of attribute information for group prediction. By masking individuals in test images and measuring the bias in group predictions (e.g., #man-to-#woman ratio), deviations from a ratio of 1 indicate attribute exploitation. Results of the experiments report Ratio=max(r, r⁻¹), where r is the observed ratio. This captures the magnitude of deviation from unbiased predictions consistently.

The methods of the present invention were compared with existing bias mitigation techniques, including dataset-level methods, such as over-sampling and subsampling, and model-level methods, such as adversarial debiasing (Adversarial), domain-independent training (DomInd), domain discriminative training (DomDisc), loss upweighting (Upweight), focal loss (Focal), class-balanced loss (CB), and group DRO (GroupDRO).

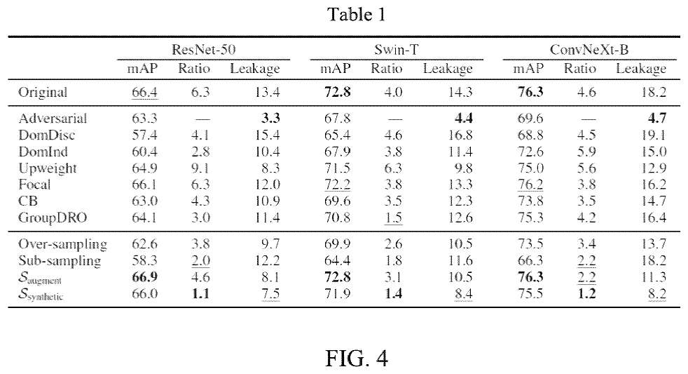

Results. Results are shown in Table 1, provided as FIG. 4. The methods of the present invention, S_{synthetic}, achieves the best balance by significantly improving both ratio and leakage while maintaining a high mAP. Specifically, S_{synthetic} achieves a near-ideal ratio of 1.1, low leakage of 7.5, and an mAP of 66.0 for ResNet-50, with similar trends observed for Swin-T and ConvNeXt-B.

Adversarial debiasing achieves lower leakage scores by removing gender information from intermediate representations. However, this method reduces mAP, indicating that object information may also be inadvertently removed. Over-sampling and sub-sampling methods address class imbalance but at the cost of model performance. Sub-sampling, in particular, reduces the ratio compared to oversampling but results in worse mAP and increased leakage. This is likely due to the loss of diversity and information in the training data, which forces the model to rely more on the remaining features, increasing the influence of protected attributes.

In contrast, S_{synthetic} generates diverse, high-quality synthetic samples, effectively balancing bias and variance. This approach avoids the pitfalls of other methods, resulting in superior performance metrics. While S_{augment} performs similarly to the original dataset, it performs worse in terms of ratio and leakage compared to S_{synthetic}.

### Image Captioning

Experimental Setup. Using the COCO dataset, captioning models ClipCap, BLIP-2, and Transformer were benchmarked, which are finetuned using early stopping. Performance was evaluated with METEOR and CLIPScore. Bias is quantified using LIC and ratio, where LIC is a leakage-based metric that assesses the generation of group-stereotypical captions compared to ground-truth captions (i.e., y is a caption in Equation (7)), and predicted group-related terms (e.g., woman) in captions used to compute ratio.

Bias mitigation baselines include dataset-level methods (Over-sampling, Sub-sampling) and the current state-of-the-art model-level method LIBRA. LIBRA is a model-agnostic debiasing framework designed to mitigate bias amplification in image captioning by synthesizing gender-biased captions and training a debiasing caption generator to recover the original captions. Methods of the present invention may be used, for example, for skin tone bias mitigation, which, along with fine-tuning specifics, showcase the generalizability of the methods of the present invention.

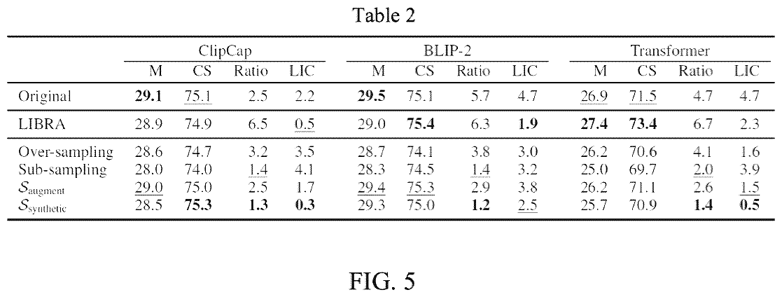

Results. Results are shown in Table 2, provided as FIG. 5. The methods of the present invention, S_{synthetic}, significantly improves both ratio and LIC while maintaining high METEOR and CLIPScore values. Specifically, S_{synthetic} achieves a near-ideal ratio of 1.3, low LIC of 1.2, and a METEOR score of 29.3 for BLIP-2, with similar trends observed for ClipCap and Transformer.

While LIBRA effectively reduces LIC, it shows an increase in the ratio metric, indicating a tradeoff between debiasing effectiveness and caption quality. Over-sampling and sub-sampling methods result in varying degrees of performance. Subsampling showed improved bias metrics compared to over-sampling but results in worse METEOR scores, especially for the Transformer model.

As in the multi-label classification task, it was observed that although S_{augment} significantly reduces bias compared to using the original dataset, there is a significant gap between it and S_{synthetic} in terms of bias mitigation.

### Analysis of Synthetic Artifacts

Recent studies show that text-to-image models introduce synthetic artifacts in images, which models may exploit. The observations above suggest that bias persists with S_{augment}, which augments the dataset with counterfactual images to balance group distributions. It can be hypothesized that S_{augment} may lead to shortcut learning due to spurious correlations between minoritized groups and inpainted artifacts. In contrast, S_{synthetic} distributes artifacts equally across all groups, avoiding this issue.

To test this, a test set was created by inpainting random body parts using COCO-WholeBody annotations. Given an image, its caption, and body part annotations (e.g., left hand, right hand, head), a body part was randomly selected, a mask was created using the Segment Anything Model, and inpainting was performed with the caption as a prompt. The consistency of ratios between the original and synthetic test sets was evaluated; a gap indicates the exploitation of synthetic artifacts for gender prediction.

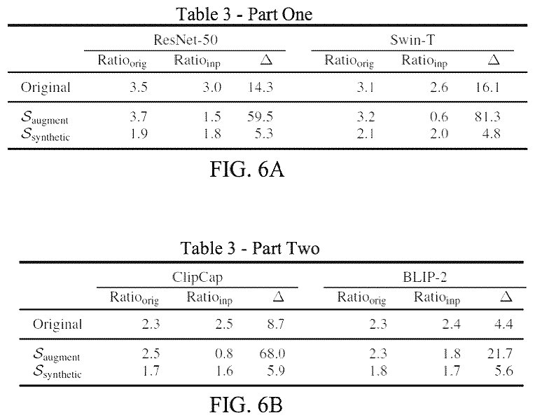

Table 3, provided as FIGS. 6A and 6B, presents scores for multi-label classification (ResNet-50, Swin-T) and image captioning (ClipCap, BLIP-2). The table includes the ratio of gender predictions (#man-to-#woman) for the original test set (Ratioorig) and the inpainted test set (Ratioinp), along with the relative difference (Δ) between these ratios. Results show a significant shift in gender predictions with S_{augment}-trained models. Despite identical gender ratios in the original and inpainted test sets (both set at 2.3), models trained with S_{augment} predict woman much more frequently for the inpainted test set, indicated by the large relative differences. In contrast, models trained solely on synthetic data (S_{synthetic}) show minimal relative differences, indicating consistent gender predictions across original and inpainted test sets.

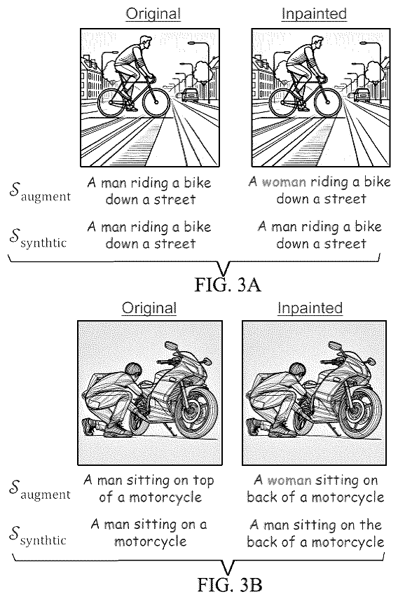

FIGS. 3A and 3B show examples of synthetic images and predictions by ClipCap (trained on S_{augment} or S_{synthetic}). The examples demonstrate inconsistent gender predictions with S_{augment}; specifically, the model tends to predict woman for the inpainted test images, evidencing exploitation of synthetic artifacts.

### Human Filter Evaluation

Human evaluations were conducted on Amazon Mechanical Turk to evaluate the effectiveness of the filters of the present invention, aiming to determine if the filters prevent additional biases from inpainting models and ensure high-quality images. For 300 randomly selected original images, inpainted images chosen by each filter combination were analyzed. Evaluations focus on the similarity of 1) held/nearby objects, 2) object color, and 3) skin tone compared to the original images. Workers assess differences between original and synthetic images for objects and their color, and selected skin tone classes using the Monk Skin Tone Scale. Additionally, workers verify accurate gender depiction through a sentence gap-filling exercise (e.g., “A______ with a dog.”), where they must choose a protected group term to complete the sentence.

For the evaluation of the similarity of objects and their colors, scores were computed as the proportion of times the inpainted images are rated as similar. Regarding the skin tone and gender evaluations, the scores were calculated as the proportion of matching responses from workers between the original and inpainted images. All the scores range from 0 to 1.

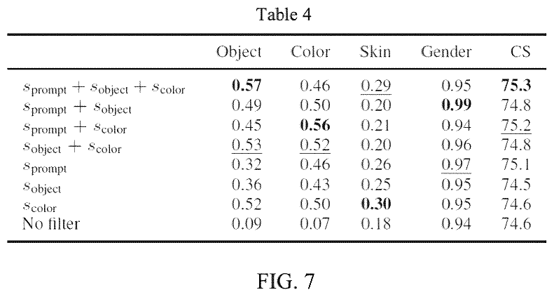

Table 4, provided as FIG. 7, summarizes the human evaluation and captioning performance of ClipCap trained on S_{synthetic} (CS), with images selected by each filter. Notably, using all filters consistently received higher ratings across most criteria. In contrast, randomly selecting images without any filtering often leads to synthetic images differing significantly from the originals. This indicates that the filters are effective in mitigating additional biases introduced by the inpainting model. Furthermore, CLIPScore shows that using all filters improves captioning performance, highlighting its effectiveness in selecting higher-quality images.

### Inherited Biases

To further discuss the potential biases introduced by the models used in our method, several assessments were conducted. First, for the object detector, Detic was run on both real and synthetic images, achieving similar mAP scores of 32.0 for real images and 32.3 for synthetic images, indicating consistent performance. Second, addressing biases in CLIP, the potential biases inherent in the model are acknowledged. However, the use of object-and color-based filters, according to aspects of the present invention, helps mitigate these biases. Additionally, image classification and captioning results verify that the methods of the present invention effectively reduces gender and skin tone biases. Lastly, for the inpainting model, the filters effectively remove synthetic images that deviate from the prompt, alter color statistics, or introduce undescribed objects, as shown in Table 4 (FIG. 7). These assessments confirm that the methods of the present invention successfully mitigates biases without compromising performance.

### Qualitative Results

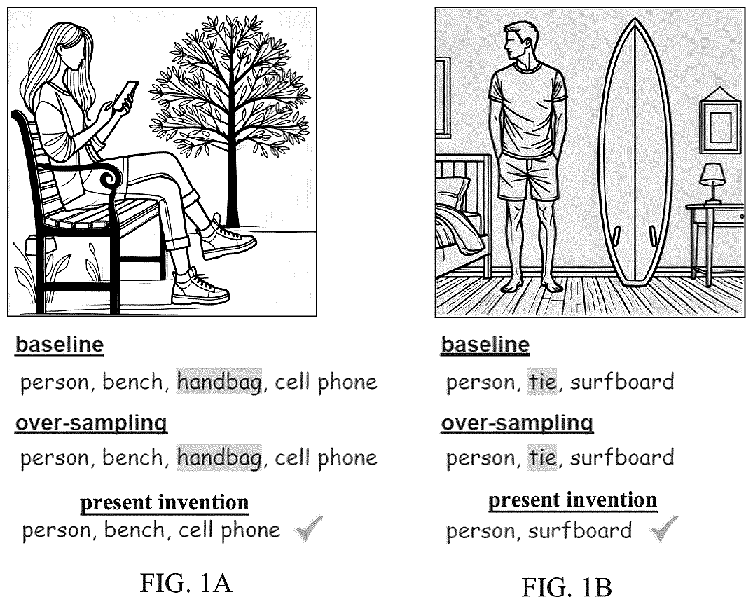

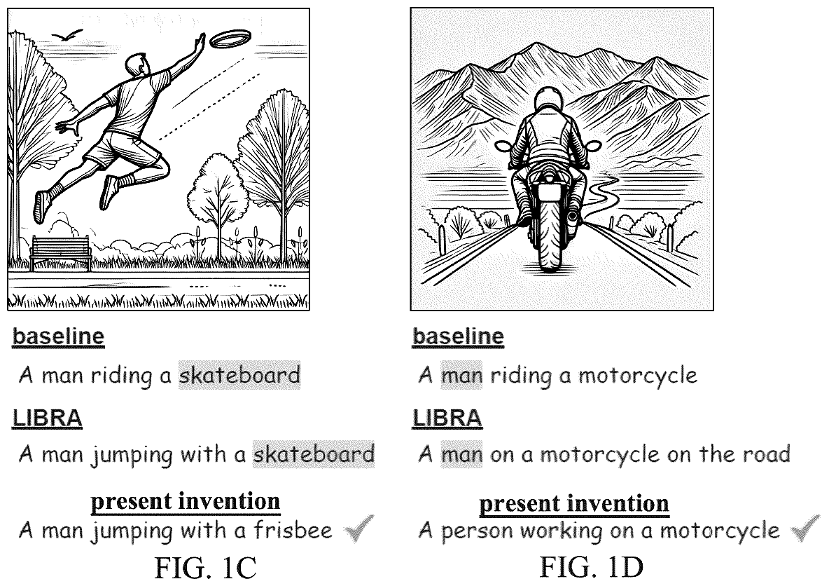

Qualitative examples of bias mitigation are presented by applying the methods of the present invention (S_{synthetic}) in FIGS. 1A and 1B. The results show that training models on S_{synthetic} produces less biased outputs. For instance, in the classification task, the baseline ResNet-50 model and the over-sampling model incorrectly predict tie, due to its frequent co-occurrence with man in the training set. In contrast, S_{synthetic} results in a gender bias-free prediction. Image captioning results further validate our approach. The baseline ClipCap model and LIBRA model generate the man-stereotypical word skateboard, whereas the methods of the present invention correctly predict the object frisbee.

The best and worst inpainted images for each filter (prompt adherence, object consistency, and color fidelity), as well as their combination (overall) can be analyzed. The results demonstrate each filter's effectiveness, and combining them selects a high-quality image that closely resembles the original. For instance, the image judged worst by the object consistency filter lacks the object the man is holding, while the color fidelity filter's worst image shows significant color changes in the man's clothing. Combining these filters helps select an inpainted image that minimizes additional bias and closely matches the original.

### Conclusion

A dataset-level bias mitigation pipeline is presented that effectively reduces gender and skin tone biases by ensuring group-independent attribute distribution using synthetic-only images. The findings indicate that mixing real and synthetic images introduces spurious correlations, underscoring the need for caution when augmenting datasets with synthetic data. Methods of the present invention highlight the potential of synthetic data in bias mitigation and suggests further exploration into optimizing synthetic data generation and integration techniques for increased bias reduction.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A computer-implemented method for mitigating societal bias in a dataset, comprising:
using a text-guided inpainting model to inpaint a person mask in an original image of the dataset with a synthetic person from a protected group to generate a synthetic image;
maintaining consistent context of the original image; and
creating a training dataset with group-independent image attribute distributions using the synthetic image.

2. The computer-implemented method of claim 1, wherein the training dataset includes multiple synthetic images for the original image.

3. The computer-implemented method of claim 2, wherein the training dataset includes only the multiple synthetic images.

4. The computer-implemented method of claim 1, wherein the training dataset includes the synthetic image and the original image.

5. The computer-implemented method of claim 2, further comprising automatically filtering the multiple synthetic images to select a least biased inpainted image as the synthetic image.

6. The computer-implemented method of claim 5, wherein the least biased inpainted image is selected based on one or more of adherence to text prompts, preservation of attributes and semantics, and color fidelity.

7. The computer-implemented method of claim 6, wherein the method provides the multiple synthetic images and the least biased inpainted image to a human evaluator to validate the automatic filtering.

8. The computer-implemented method of claim 5, wherein the automatic filtering includes:
assigning weights to each of a plurality of filters;
bias scoring each of the multiple synthetic images across each of the plurality of filters; and
selecting one of the least biased inpainted image based on a minimization of a sum of the scoring for each of the plurality of filters.

9. The computer-implemented method of claim 1, wherein the text-guided inpainting model is guided by a text prompt containing a protected group-specific word.

10. The computer-implemented method of claim 1, further comprising reducing prediction rules based on spurious correlations in multi-label classifications and image captioning across various architectures, datasets, and protected groups.

11. A computer-implemented method for generating a synthetic training dataset with group-independent image attribute distributions, comprising:
using a text-guided inpainting model to inpaint a person mask in an original image of an original dataset with a synthetic person from a protected group to generate a synthetic image;
maintaining consistent context of the original image; and
creating the synthetic training dataset with group-independent image attribute distributions using the synthetic image, wherein
the synthetic training dataset includes multiple synthetic images for the original image.

12. The computer-implemented method of claim 11, wherein the synthetic training dataset includes only multiple synthetic images for each original image of the original dataset.

13. The computer-implemented method of claim 11, wherein the synthetic training dataset includes the synthetic image and the original image.

14. The computer-implemented method of claim 11, further comprising automatically filtering the multiple synthetic images generated from one of the original images to select a least biased inpainted image as the synthetic image.

15. The computer-implemented method of claim 14, wherein the least biased inpainted image is selected based on one or more of adherence to text prompts, preservation of attributes and semantics, and color fidelity.

16. A non-transitory computer readable storage medium tangibly embodying a computer readable program code having computer readable instructions that, when executed, causes a computer device to carry out a method of for generating a synthetic training dataset with group-independent image attribute distributions, the method comprising:
using a text-guided inpainting model to inpaint a person mask in an original image of an original dataset with a synthetic person from a protected group to generate a synthetic image;
maintaining consistent context of the original image; and
creating the synthetic training dataset with group-independent image attribute distributions using the synthetic image, wherein
the synthetic training dataset includes multiple synthetic images for the original image.

17. The non-transitory computer readable storage medium of claim 16, wherein the synthetic training dataset includes only multiple synthetic images for each original image of the original dataset.

18. The non-transitory computer readable storage medium of claim 16, wherein the synthetic training dataset includes the synthetic image and the original image.

19. The non-transitory computer readable storage medium of claim 16, wherein the method further comprises automatically filtering the multiple synthetic images generated from one of the original images to select a least biased inpainted image as the synthetic image.

20. The non-transitory computer readable storage medium of claim 19, wherein the least biased inpainted image is selected based on one or more of adherence to text prompts, preservation of attributes and semantics, and color fidelity.
